(19) United States
(12) Patent Application Publication
(10) Pub. No.: US 2024/0238797 A1
(43) Pub. Date: Jul. 18, 2024

(54) SPIRAL JET MILL AND METHOD FOR GRINDING MATERIALS TO BE GROUND IN A SPIRAL JET MILL

(71) Applicant: LANXESS DEUTSCHLAND GMBH, D-50569 KÖLN (DE)

(72) Inventors: Bartholomäus Luczak, Krefeld (DE); Rolf MÜLLER, Krefeld (DE); Tim PESCH, Krefeld (DE)

(73) Assignee: LANXESS DEUTSCHLAND GMBH, D-50569 KÖLN (DE)

(21) Appl. No.: 18/289,848

(22) PCT Filed: May 13, 2022
(86) PCT No.: PCT/EP2022/063088

§ 371 Date: Nov. 7, 2023

(30) Foreign Application Priority Data
May 14, 2021 (EP) 21173898.4

(51) Int. Cl. B02C 19/06; B02C 25/00

(52) U.S. Cl. CPC B02C 19/061; B02C 25/00

(57) ABSTRACT

The invention relates to a spiral jet mill (1) having a grinding chamber (10), which is delimited by a bottom (11), a cover (12), and a wall (13) that connects the bottom (11) and the cover (12), and having a plurality of grinding gas nozzles (14) that pass through the wall (13) and are connected to a grinding gas source, wherein each of at least part of the grinding gas nozzles (14) is provided with an associated switchable shut-off mechanism (15), which is able to independently open and close the connection to the grinding gas source. In addition, a method for grinding milling materials in a spiral jet mill is also disclosed.

### BACKGROUND OF THE INVENTION

### Field of the Invention

This invention relates to a spiral jet mill having a grinding chamber, which is delimited by a bottom, a cover, and a wall that connects the bottom and the cover, and having a plurality of grinding gas nozzles that pass through the wall and are connected to a grinding gas source. In addition, this invention also relates to a method for grinding milling materials in such a spiral jet mill into which the milling materials are introduced and are acted on with a grinding gas flow from a plurality of grinding gas nozzles that pass through the wall.

### Discussion of Related Art

Spiral jet mills of the type mentioned above have been known for a long time and are now used very frequently in industrial applications when it is necessary to produce particles with diameters of less than approximately 10 μm, particularly in the pharmaceutical, special chemical, and fine chemical industries. The operating principle of the spiral jet mill is based on the fact that the milling material introduced into the grinding chamber is subjected to the action of a powerful grinding gas flow that has been accelerated to speeds of several hundred meters per second and travels into the grinding chamber from the grinding gas nozzles that pass through the wall. Because the grinding gas nozzles are usually directed into the grinding chamber at a roughly tangential angle, the flow of the incoming grinding gas takes on a spiral shape in the grinding chamber. The supplied milling material is captured by the gas jets, accelerated, and comminuted by reciprocal particle collisions. The milling material that has the desired grain size is discharged from the grinding chamber together with the calmed grinding gas at the rotational center point of the spiral flow while particles that are too coarse are subjected to additional grinding action. To this extent, a spiral jet mill has no need for moving built-in elements inside the grinding chamber and enables the production of a particularly fine milling material with a relatively narrow particle size distribution and virtually no appreciable mechanical wear. The above-mentioned advantages of the spiral jet mill, however, are accompanied by disadvantages in the form of a relatively high energy input and a complex regulation with regard to an optimal operating point because many influence parameters such as the dimensions of the grinding chamber, the entry angle of the grinding gas nozzles or also the mass flow of the grinding gas, or the product ratio can be varied within broad limits, particularly as a function of the milling material. The basic design of such a spiral jet mill can be seen, for example, in European Patent Reference EP 3 613 508 A1.

Up to this point in the prior art, the comminution intensity and action are achieved by regulating the grinding gas mass flow or grinding gas pressure by inserting a throttle valve into a central supply line for the grinding gas between the grinding gas source and the spiral jet mill or by regulating the grinding gas source itself, for example a compressor. For example, reference can be made to PCT Reference WO 2019/155038 A1, PCT Reference WO 2017/042341 A1, U.S. Patent Publication US 2004211849, and PCT Reference WO 2013/156465 A1. It has turned out, however, that with continued reduction of the pressure of the grinding gas flow, the speed of this flow at the outlet of the grinding gas nozzles into the grinding chamber is likewise reduced, which has a very powerful negative impact on the grinding action and efficiency, which would appear to be in need of improvement.

Chinese Patent Reference CN 203990833 U also discloses a jet mill in which two air nozzles arranged in opposing positions are combined with a bottom nozzle oriented vertically upward. The application of compressed air from a shared supply line of a compressor is adjusted at the beginning of the grinding procedure by separate control valves and flow measuring devices positioned at the nozzles so that exactly identical air flows come out of all three nozzles. Only when such an equilibrium state is achieved is the material supply opened, wherein the opening cross-section of the latter can be changed in order to adapt to the milling material. This is very complicated and is difficult to adjust for changing grinding tasks.

### SUMMARY OF THE INVENTION

One object of this invention is to provide a spiral jet mill and a method for grinding bulk materials in a spiral jet mill, which despite an improved controllability of the grinding procedure, is accompanied by a significantly more efficient grinding at a high output.

To attain the above object and others, this invention provides for a spiral jet mill to be embodied with the features described in this specification and in the claims.

The proposal according to this invention provides an embodiment of a spiral jet mill in which each of at least part of the grinding gas nozzles that are present is provided with an associated switchable shut-off mechanism, which is able to open and close the connection to the grinding gas source independently of the other shut-off mechanisms.

According to this invention, a spiral jet mill is provided in which through the opening or closing of the respectively associated shut-off mechanisms, the installed grinding gas nozzles can be individually switched on and off and open or close the connection of the associated grinding gas nozzle to the grinding gas source. Consequently, with the spiral jet mill according to this invention, it is possible to regulate the flow of the grinding gas into the grinding chamber exclusively by the number of switched-on nozzles and the nozzle cross-section that is thus available for admitting the grinding gas. In this case, regardless of the number of currently open shut-off mechanisms and associated grinding gas nozzles, the optimal maximum operating pressure of the grinding gas source is always present and the grinding gas is correspondingly introduced into the grinding chamber with an optimally high speed by the open grinding gas nozzles. Even with a decrease or increase in the number of opened shut-off mechanisms and associated grinding gas nozzles, there is no change in the pressure of the grinding gas that is present at the grinding gas nozzles and no change in the discharge speed into the grinding chamber. The grinding action and efficiency are therefore improved significantly in comparison to the spiral jet mills that have been pressure-regulated before now.

According to this invention, at least part of the grinding gas nozzles are equipped with associated switchable shut-off mechanisms in the manner according to this invention.

Thus according to this invention, each of at least part of the grinding gas nozzles is provided with an associated switchable shut-off mechanism, which is able to independently open and close the respective connection of the grinding gas nozzle to the grinding gas source in order to switch the grinding gas nozzles on and off. Each grinding gas nozzle that is equipped with an associated shut-off mechanism can, independently of the other grinding gas nozzles, be connected to the grinding gas source through corresponding actuation of the associated shut-off mechanism into the open position in order to introduce grinding gas into the grinding chamber or can, through actuation of the associated shut-off mechanism, be disconnected from the grinding gas source in order not to introduce any grinding gas into the grinding chamber. Thus, it is possible to vary the grinding gas flow by increasing the number of grinding gas nozzles, which are connected to the grinding gas source and introduce grinding gas into the grinding chamber, through a corresponding opening of the respective associated shut-off mechanisms or by decreasing this number through a closing of the respective associated shut-off mechanisms.

According to one embodiment of this invention, it is also in particular possible for all of the grinding gas nozzles of the spiral jet mill according to this invention to each be equipped with a respective associated switchable shut-off mechanism in order to be able to switch them on and off as needed.

For purposes of this invention, possible shut-off mechanisms especially include shut-off valves, ball valves, gate valves, and similar shut-off devices, which permit a rapid switching between the open and closed state.

According to another embodiment of this invention, the grinding gas source communicates with these grinding gas nozzles by separate supply lines that each lead to a respective grinding gas nozzle, wherein the switchable shut-off mechanism is provided in the supply lines. This enables a space-saving arrangement of the shut-off mechanisms and makes it possible to associate each individual grinding gas nozzle with an individually controllable supply of grinding gas from the grinding gas source.

A particular advantage of the embodiment of the spiral jet mill according to this invention is that except for the modification of the grinding gas supply to the individual grinding gas nozzles and the integration of the associated shut-off mechanisms, the rest of the components of the spiral jet mill, in particular the grinding chamber, which is defined by a bottom, a cover, and a wall that connects the bottom and the cover, and the corresponding supply and discharge openings for the milling material, remain unchanged so that the embodiment according to this invention can also be achieved as part of a modification or retrofitting of already existing spiral jet mills.

The spiral jet mill according to this invention includes one grinding gas nozzle, but preferably a plurality of grinding gas nozzles distributed around the circumference of the wall, wherein according to one embodiment of this invention, in particular 3 to 40 such grinding gas nozzles are provided, which are positioned at regular intervals or combined in groups distributed around the circumference of the wall.

According to this invention, the grinding gas nozzles can be embodied as de Laval nozzles, which produce a particularly high discharge speed of the grinding gas into the grinding chamber, which is advantageous for the grinding result. Up to now, such an embodiment of the grinding gas nozzles as de Laval nozzles could only be achieved with difficulty because with the conventional regulation of the spiral jet mill by means of the grinding gas pressure that is present, the optimal operating point of the de Laval nozzles could only be utilized to a very limited degree. With the embodiment according to this invention, however, because there is no need to regulate the grinding gas pressure that is present, it is almost always possible to utilize the optimal operating point of the de Laval nozzles and to accelerate the grinding gas to several times the speed of sound, which results in an optimized grinding action.

According to another embodiment of this invention, a control unit is provided for the independent actuation of the shut-off mechanisms in order to actuate the individual shut-off mechanisms and associated grinding gas nozzles to open or close in a manner that is adapted to the respective regulating task.

According to this invention, the shut-off mechanisms are preferably embodied so that they can be switched exclusively between a completely open state and a completely closed state, or open/closed. As part of a presetting of the spiral jet mill for an upcoming grinding task prior to the starting of the mill, however, the switching of the shut-off mechanisms can likewise also be carried out during continuous operation of the spiral jet mill in order to regulate individual process parameters. The switching on and off of individual grinding gas nozzles of the spiral jet mill according to this invention can, for example, be carried out based on the desired degree of comminution depending on the type and hardness of the milling material and/or the internal pressure of the grinding chamber.

According to another embodiment, the spiral jet mill according to this invention can also be embodied in particular with a cylindrical wall so that between the bottom and the cover, a corresponding circular cylindrical grinding chamber is defined into which individual grinding gas nozzles, which can be switched with the associated shut-off mechanisms, feed at a predetermined entry angle. In this case, the bottom and cover can be embodied either as flat or as arched in order to correspondingly give the grinding chamber a cylindrical or lenticular shape.

In addition, an inlet opening for supplying the milling material into the grinding chamber and also a discharge opening for discharging the milling material that has been ground in the grinding chamber are embodied in the cover of the spiral jet mill according to this invention.

The method according to this invention for grinding milling materials in a spiral jet mill is based on the fact that the spiral jet mill has a grinding chamber, which is delimited by a bottom, a cover, and a wall and into which the milling material is introduced and acted on by a grinding gas flow from a plurality of grinding gas nozzles that pass through the wall. According to this invention, the grinding gas flow is regulated by varying the number of grinding gas nozzles that are acted on with the grinding gas flow.

Whereas in spiral jet mills according to the prior art, a regulation of the grinding procedure is usually achieved by regulating, in particular throttling, the flow of the grinding gas by a central inlet, which to this extent inevitably involves a loss of pressure and speed at all of the grinding gas nozzles, with the method according to this invention, it is possible to adapt the flow of the grinding gas into the grinding chamber by the number of grinding gas nozzles that are acted on by the grinding gas flow, wherein the grinding gas coming out of the grinding gas nozzles that are acted by the grinding gas flow always flows into the grinding chamber at the maximum pressure and maximum speed.

In the context of this invention, it has turned out that this approach permits a regulation/control of the spiral jet mill in a broader range than was possible in the prior art.

In particular, this invention provides for the grinding gas nozzles to be opened and acted on with the grinding gas flow or closed and disconnected from the grinding gas flow separately and independently from the other grinding gas nozzles. In particular, this opening and closing can be carried out by switchable shut-off mechanisms that are correspondingly associated with the grinding gas nozzles and are positioned in the separate supply lines for the grinding gas that lead to each individual grinding gas nozzle.

According to another embodiment, of this invention, the flow of grinding gas into the grinding chamber per unit time is regulated by changing the number of grinding gas nozzles that are acted on with the grinding gas flow so that the method according to this invention permits a particularly efficient and variable adaptation of the grinding procedure in the spiral jet mill to the specific properties of the milling material and to the respective grinding task.

The application of the grinding gas flow to individual grinding gas nozzles or the disconnection of the flow depending on the desired regulation can be carried out in almost any configuration.

According to one embodiment, of this invention, viewed in the direction around the circumference of the wall, a regular sequence of grinding gas nozzles are opened or closed in alternating fashion, for example, in an alternating pattern of open-closed-open-closed, and the like. It is also possible to concurrently apply the grinding gas flow to respectively adjacent grinding gas nozzles or to disconnect it from them, for example, to open two or more adjacent grinding gas nozzles and to correspondingly close the subsequent number of adjacent grinding gas nozzles.

According to another embodiment of this invention, it is also conceivable, viewed in the direction around the circumference of the wall, to close a number of adjacent successive grinding gas nozzles in the form of a sector and to open the remaining grinding gas nozzles, wherein the number of grinding gas nozzles included in the closed sector and, correspondingly, the number of remaining open grinding gas nozzles can be freely selected.

The method according to this invention is thus characterized by an extremely wide regulation bandwidth. It is, however, essential that the supply of the grinding gas is not subjected to energy-inefficient throttling. Instead, the highest possible operating pressure of the grinding gas source is present at each individual grinding gas nozzle, regardless of whether the respective grinding gas nozzle is open and is also being acted on by the grinding gas flow or is closed and is disconnected from the grinding gas flow.

The comminution effect and comminution intensity that are achievable in the spiral jet mill according to this invention are therefore adapted not by regulating the grinding gas source, but rather by switching individual grinding gas nozzles on and off and acting on them with the grinding gas. The number of grinding gas nozzles that are acted on with the grinding gas flow is varied in order to adjust the overall grinding gas flow that is introduced into the grinding chamber, but the pressure of the grinding gas upstream of each individual grinding gas nozzle remains as high as possible so that the achievable discharge speeds of the grinding gas into the grinding chamber via the grinding gas nozzles that are acted on by the grinding gas flow also remain correspondingly high, which results in an efficient utilization of the kinetic energy of the grinding gas.

In one simple case, the grinding gas nozzles that are used can have cylindrical or conical nozzle cross-sections. In a modification of this invention, however, they can also be embodied as de Laval nozzles and can accelerate the exiting grinding gas to a speed in the range from one to several times the speed of sound.

According to another embodiment of this invention, the grinding gas nozzles are in particular also opened or closed during the time that the grinding chamber is acted on with the grinding gas flow so that it is easily possible to regulate the spiral jet mill even during continuous operation, for example, in order to react to changes in other influence parameters or disturbance variables during operation.

The opening or closing of the grinding gas nozzles is preferably carried out as a function of the desired grain size, hardness of the milling material, and/or pressure of the grinding chamber and must be selected by the person skilled in the art in accordance with the requirements.

### BRIEF DESCRIPTION OF THE DRAWINGS

Other embodiments and details of this invention will be explained below based on the drawings, which show an exemplary embodiment, wherein:

FIG. 1 shows a schematic depiction of a view of a spiral jet mill according to this invention;

FIG. 2 is an enlarged depiction showing a section taken through the spiral jet mill according to FIG. 1; and

FIG. 3 is another enlarged depiction showing a milling material supply of the spiral jet mill according to this invention shown in FIG. 1.

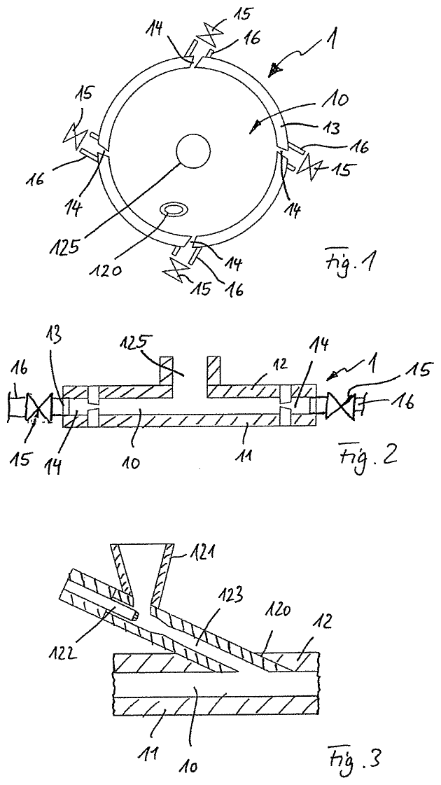

### DETAILED DESCRIPTION OF THE INVENTION

The figures show a simplified schematic depiction of a spiral jet mill 1 for grinding milling materials of the kind that is used, for example, in the pharmaceutical, special chemical, and fine chemical industry, for example, for grinding particulate solids.

In this context, “particulate solids” are understood to include, for example, iron oxides, in particular α-, β-, γ- and/or δ-FeOOH phases and/or Fe(OH)2 phases, ferrihydrite phases as well as mixed and intermediate phases thereof, particularly preferably hematite, the modification α Fe2O3, γ-Fe2O3 maghemite, magnetite, manganese- or zinc ferrites, titanium dioxides such as in the rutile or anatase modification or as rutile mixed-phase pigments, chromium oxides, zinc oxides, zinc sulfides, ultramarine, nickel or chromium antimony titanium dioxides, cobalt blue, cobalt green, chromium oxides, or carbon forms such as carbon black, graphite, or graphene. Inorganic pigments from the above-mentioned group are mentioned as being particularly preferable.

The spiral jet mill 1 comprises a circular cylindrical, closed grinding chamber 10, which is delimited by a bottom 11, a cover 12 that is spaced apart from the bottom 11, and a wall 13 that connects the bottom 11 and the cover 12. The wall 13 thus likewise has a circular cylindrical embodiment. Through a corresponding arching of the bottom 11 and/or cover 12, the grinding chamber 10 can also have a lenticular shape.

The wall 13 is penetrated by a number of grinding gas nozzles 14, a total of four in the example shown here, which feed into the grinding chamber 10 at a predetermined entry angle that is roughly tangential.

Via or by supply lines 16 that are merely indicated, the grinding gas nozzles 14 communicate with a grinding gas source that is not shown, for example, a compressor, and are acted on with a corresponding grinding gas flow from it, for example compressed air. Via or by the grinding gas nozzles, the grinding gas travels roughly tangentially into the grinding chamber 10 and in the exemplary embodiment shown, produces a spiral-shaped counter-clockwise grinding gas flow inside the grinding chamber 10.

Via or by an inlet opening 120, which is positioned off-center in the region of or near the cover 12 and is shown in greater detail in FIG. 3, the milling material is supplied via or by a funnel 121 from a corresponding storage receptacle and by a gas flow emitted by an injector nozzle 122, is accelerated in an injector tube 123 and introduced into the grinding chamber 10. In this chamber, the milling material is captured and entrained by the grinding gas flow that rotates in a spiral shape, wherein the acceleration forces and collisions of the individual pieces of the milling material bring about the desired comminution and grinding of the milling material. Once the milling material falls below a desired grain size, it collects in the central region of the grinding chamber 10 due to the decreasing centrifugal forces in the spiral flow and from there, is discharged from the spiral jet mill 1 together with the calmed grinding gas via a central discharge opening 125 likewise provided in the cover 12, possibly with the use of filters or cyclones that are not shown here.

An essential feature for the spiral jet mill shown is that in order to regulate the grinding procedure inside the grinding chamber 10, each individual grinding gas nozzle 14, in the region of or near its supply line 16 for the grinding gas, is provided with a separately and independently controllable shut-off mechanism 15, and these make it possible to act on any one of the individual grinding gas nozzles 14 with the grinding gas flow and correspondingly activate it or to disconnect it from the grinding gas flow and correspondingly deactivate it. As soon as a shut-off mechanism 15 is opened, the corresponding grinding gas nozzle 14 is acted on with the grinding gas of the grinding gas source and conversely, is disconnected from the grinding gas as soon as the associated shut-off mechanism 15 is closed. The shut-off mechanisms 15 can, for example, be embodied by shut-off valves that can be switched between an open and closed position.

In this way, a constantly high operating pressure of the grinding gas from the grinding gas source can be applied in all of the supply lines 16 and, by opening individual shut-off mechanisms 15 or all of them, a corresponding number of associated grinding gas nozzles 14 can be activated from which the grinding gas flow then travels into the grinding chamber 10 at a constant pressure and a correspondingly constant maximum speed.

Such a switching on and off of individual grinding gas nozzles 14 can be used to adjust the comminution action and intensity of the spiral jet mill 1 by changing the total grinding gas flow into the grinding chamber 10 without reducing the discharge speed of the grinding gas into the grinding chamber 10. This results in one most efficient possible utilization of the grinding gas and a significantly more energy-efficient operation of the spiral jet mill 1.

The number of open and closed shut-off mechanisms 15 and associated grinding gas nozzles 14 can be selectively changed before and during the operation of the spiral jet mill. In the exemplary embodiment shown, for example, every other grinding gas nozzle 14 can be acted on with the grinding gas flow by opening the associated shut-off mechanisms 15. It is also possible, however, for only one individual grinding gas nozzle 14 to be opened or for three adjacent grinding gas nozzles 14 or all of the grinding gas nozzles 14 to be opened. The same is true for spiral jet mills 1 with a larger or smaller number of grinding gas nozzles, with numbers ranging from 3 to 40 such grinding gas nozzles 10 being considered as suitable in the context of this invention. The respective currently desired actuation of the individual shut-off mechanisms 15 can advantageously be carried out by a corresponding control unit, for example, in accordance with an electronic system control.

In comparison to embodiments of spiral jet mills that were used previously, the depicted embodiment of a spiral jet mill 1 has modifications only in the region of or near the supply of the grinding gas to the individual grinding gas nozzles 14 in that each individual grinding gas nozzle 14 is equipped with a separate supply line 16 in which an independently switchable shut-off mechanism 15 is provided. Previously customary pre-distributors and pressure regulating devices for the supplied grinding gas, however, can be eliminated.

In comparison to the previously used pressure regulation of the grinding gas in order to control the flow of the grinding gas into the grinding chamber 10, the embodiment explained above achieves an ideally constant high pressure at the inlet of the grinding gas nozzles. This makes it possible to embody the grinding gas nozzles not only as cylindrical or conical, but also in the form of de Laval nozzles. Through the above-explained switching on and off of individual grinding gas nozzles, possibly with an adaptation of the milling material discharge flow, it is possible to adapt the pressure in the grinding chamber 10, but a constantly high pressure is always present at the open grinding gas nozzles. The individual open grinding gas nozzles can thus always be operated in the vicinity of or near the optimal operating point, which particularly when embodied as de Laval nozzles, ensures an energy-efficient operation since extremely high exit speeds of the grinding gas of up to several times the speed of sound with a low jet divergence can be achieved. This is reflected in a much more energy-efficient grinding action.

Energy losses that do not contribute to the comminution and are due to compression impacts or large jet divergences due to the operation of grinding gas nozzles 14 embodied as de Laval nozzles above or below the optimal operating point can be reliably avoided by keeping the grinding gas pressure and the pressure inside the grinding chamber 10 constant.

Even when, for example, cylindrical grinding gas nozzles 14 are used, the exit speed of the grinding gas into the grinding chamber 10 can be increased up to the speed of sound by limiting the number of active and open grinding gas nozzles 14 with a predetermined flow of milling material, which likewise enables an energy-efficient grinding.

A conventional flow limiting by regulating the pressure of the grinding gas also inevitably reduces the pressure of the grinding gas that is present at the grinding gas nozzles, which is accompanied by a corresponding reduction in the speed of the grinding gas flow discharged from the grinding gas nozzles and negatively affects the energy balance. With the above-explained regulation of the flow by reducing the number of available grinding gas nozzles 14 that are acted on with the grinding gas flow, the flow of the grinding gas is likewise reduced to the desired degree, but the maximum pressure is still present at the open grinding gas nozzles 14, which means that the maximum flow speed of the discharged grinding gas is also still achieved without any change. This achieves a powerful improvement of the previously inevitable energy-inefficient operation of the spiral jet mill.

The spiral jet mill explained above and the method can be achieved not only in newly constructed spiral jet mills, but also as part of a comparatively simple retrofit of already existing spiral jet mills according to the prior art.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A spiral jet mill having a grinding chamber, which is delimited by a bottom, a cover, and a wall that connects the bottom and the cover, and having a plurality of grinding gas nozzles that pass through the wall and are connected to a grinding gas source, characterized in that comprising each of at least part of the grinding gas nozzles is provided with an associated switchable shut-off mechanism, which is able to independently open and close the connection to the grinding gas source.

2. The spiral jet mill according to claim 1, wherein each grinding gas nozzle is provided with an associated switchable shut-off mechanism.

3. The spiral jet mill according to claim 1, wherein the grinding gas source communicates with the grinding gas nozzles by supply lines that each lead to a respective grinding gas nozzle, wherein the switchable shut-off mechanism is provided in the supply lines.

4. The spiral jet mill according to claim 3, wherein 3 to 40 grinding gas nozzles are provided.

5. The spiral jet mill according to claim 1, wherein the grinding gas nozzles are embodied as de Laval nozzles.

6. The spiral jet mill according to claim 5, wherein a control unit is provided for independently triggering the shut-off mechanisms.

7. The spiral jet mill according to claim 6, wherein the wall is embodied as cylindrical.

8. The spiral jet mill according to claim 7, wherein an inlet opening for supplying the milling material into the grinding chamber and a discharge opening for discharging the milling material that has been is ground in the grinding chamber are embodied in the cover.

9. A method for grinding milling materials in a spiral jet mill, wherein the spiral jet mill has a grinding chamber, which is delimited by a bottom, a cover, and a wall and into which the milling material is introduced and acted on by a grinding gas flow from a plurality of grinding gas nozzles that pass through the wall, wherein the grinding gas flow is regulated by varying the number of grinding gas nozzles that are acted on with the grinding gas flow.

10. The method according to claim 9, wherein grinding gas nozzles are opened and acted on by the grinding gas flow or closed and disconnected from the grinding gas flow separately and independently from the other grinding gas nozzles.

11. The method according to claim 10, wherein in order to regulate the grinding gas flow, the flow of grinding gas into the grinding chamber per unit time is varied by changing the number of grinding gas nozzles that are acted on with the grinding gas flow.

12. The method according to claim 11, wherein viewed in the direction around the circumference of the wall, a regular sequence of grinding gas nozzles are opened or closed in alternating fashion.

13. The method according to claim 11, wherein viewed in the direction around the circumference of the wall, a number of grinding gas nozzles adjacent to one another in sequence are closed or opened.

14. The method according to claim 13, wherein the grinding gas nozzles are opened or closed during the time that the grinding chamber is being acted on with the grinding gas flow.

15. The method according to claim 14, wherein the grinding gas flow from the grinding gas nozzles is introduced into the grinding chamber at supersonic speed.

16. The method according to claim 15, wherein the opening or closing of the grinding gas nozzles is varied as a function of the desired grain size of the milling material, the hardness of the milling material, and/or the pressure in the grinding chamber.

17. The spiral jet mill according to claim 1, wherein the grinding gas source communicates with the grinding gas nozzles by supply lines that each lead to a respective grinding gas nozzle, wherein the switchable shut-off mechanism is provided in the supply lines.

18. The spiral jet mill according to claim 1, wherein 3 to 40 grinding gas nozzles are provided.

19. The spiral jet mill according to claim 1, wherein the grinding gas nozzles are embodied as de Laval nozzles.

20. The spiral jet mill according to claim 1, wherein a control unit is provided for independently triggering the shut-off mechanisms.

21. The spiral jet mill according to claim 1, wherein the wall is embodied as cylindrical.

22. The spiral jet mill according to claim 1, wherein an inlet opening for supplying the milling material into the grinding chamber and a discharge opening for discharging the milling material that is ground in the grinding chamber are embodied in the cover.

23. The method according to claim 9, wherein in order to regulate the grinding gas flow, the flow of grinding gas into the grinding chamber per unit time is varied by changing the number of grinding gas nozzles that are acted on with the grinding gas flow.

24. The method according to claim 9, wherein viewed in the direction around the circumference of the wall, a regular sequence of grinding gas nozzles are opened or closed in alternating fashion.

25. The method according to claim 9, wherein viewed in the direction around the circumference of the wall, a number of grinding gas nozzles adjacent to one another in sequence are closed or opened.

26. The method according to claim 9, wherein the grinding gas nozzles are opened or closed during the time that the grinding chamber is being acted on with the grinding gas flow.

27. The method according to claim 9, wherein the grinding gas flow from the grinding gas nozzles is introduced into the grinding chamber at supersonic speed.

28. The method according to claim 9, wherein the opening or closing of the grinding gas nozzles is varied as a function of the desired grain size of the milling material, the hardness of the milling material, and/or the pressure in the grinding chamber.
